(19) United States
(12) Patent Application Publication
(10) Pub. No.: US 2005/0138545 A1
(43) Pub. Date: Jun. 23, 2005

(54) Efficient universal plug-and-play markup language document optimization and compression

(76) Inventors: Ylian Saint-Hilaire, Hillsboro, OR (US); Bryan Y. Roe, Camas, WA (US); Nelson F. Kidd, Camas, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/744,681

(22) Filed: Dec. 22, 2003

(51) Int. Cl. G06F 15/00

(52) U.S. Cl. 715/513

(57) ABSTRACT

A method, machine readable medium, and system are disclosed. In one embodiment the method comprises optimizing a web-based markup language document by removing all non-functional characters, compressing the document, storing the compressed and optimized document directly in a universal plug and play stack, and decompressing and transmitting the document in real-time in response to any given access request.

### FIELD OF THE INVENTION

The invention is related to the Internet. More specifically, the invention relates to compression and optimization of markup language documents in a Universal Plug and Play environment.

### BACKGROUND OF THE INVENTION

The advent of the Universal Plug and Play (UPnP) standard has led to new benefits of communication and interoperability between many devices connected to a network. UPnP enables the discovery and control of networked devices and services, such as mobile computers, servers, printers, and consumer electronic devices. A UPnP-enabled device can dynamically connect to a network, obtain an IP address, convey its capabilities, and learn about the presence and capabilities of other devices without any user intervention. As computing and network technology is incorporated within more and more devices and appliances the demand for small, fast, and efficient UPnP technology becomes greater.

Unlike the desktop PCs of today, many potential UPNP devices do not have powerful CPUs or large storage capabilities. Many handheld devices such as personal digital assistants (PDAs), cell phones, and remote controls among others benefit from UPNP functionality. Additionally, electronic appliances such as dishwashers, TVs, and refrigerators can also take advantage of UPnP capabilities to create a truly network connected home or business. To accomplish this connectivity and communication among these wide range of devices UPnP provides support for communication between devices. The actual network, the TCP/IP protocol, and HTTP provide basic network connectivity and addressing. On top of these standard Internet-based protocols, UPnP defines a UPnP protocol stack to handle discovery, description, control, events, and presentation among the connected devices.

The UPnP stack must be very small in order to run not only on PCs but also on all the small embedded devices such as digital cameras, audio players, remote controls, etc. A common UPnP stack is about 60-90 Kbytes, but about 20-25% of that size are static or mostly static Extensible Markup Language (XML) documents. XML documents, in regard to UPnP, are used for device and service descriptions, control messages, and eventing. All UPnP devices must be able to describe themselves upon request. The description of a UPnP device is encoded in a device description document and one or more service description documents.

Therefore, what is needed is a method for effectively optimizing and compressing these XML documents for storage on a device as well as for efficiently decompressing the documents on the fly when a document located on a device is requested by another device or control point on the network.

### BRIEF DESCRIPTION OF DRAWINGS

The present invention is illustrated by way of example and is not limited by the figures of the accompanying drawings, in which like references indicate similar elements, and in which:

FIG. 1 illustrates an overview of the functionality of one embodiment of the present invention.

FIG. 2 illustrates a process of steps that detail one embodiment of the present invention.

FIG. 3 illustrates a process of steps that detail the compression scheme in one embodiment of the present invention.

FIG. 4 illustrates one example of the compression scheme working in one embodiment of the present invention.

### DETAILED DESCRIPTION

Embodiments of an efficient universal plug-and-play markup language document optimization and compression scheme are disclosed. In the following description, numerous specific details are set forth. However, it is understood that embodiments may be practiced without these specific details. In other instances, well-known circuits, structures and techniques have not been shown in detail in order not to obscure the understanding of this description.

Reference throughout this specification to “one embodiment” or “an embodiment” indicate that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

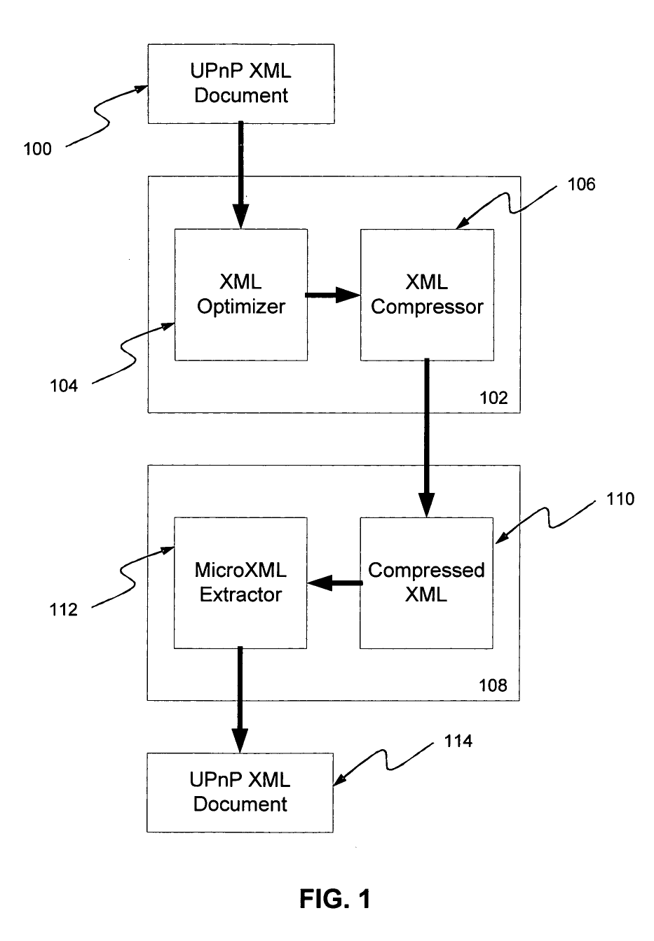

FIG. 1 illustrates an overview of the functionality of one embodiment of the present invention. In one embodiment a given UPnP XML document 100 is added to the UPNP stack within a UPnP-enabled device. This document could be any one of a number of XML documents added to the UPNP stack for the device such as the device description document or a service description document among others. Next, the Device Builder 102 receives the document and makes a first pass by optimizing the document in the XML Optimizer 104. The XML Optimizer 104 removes all excess characters from the XML document such as comments, line feeds, carriage returns, spaces and tabs. This pares the XML document down to its essential size, the only characters remaining are the data within the document and the functional scripting characters used in the XML language. The optimized XML page is sent to the XML Compressor 106, which compresses the document down to a nearly optimal size.

The document is then stored as compressed XML 110 directly in the UPnP stack, referred to as the Microstack 108 because of the smaller size with the optimized and compressed XML document. When the device fields a request from a second device for the document, such as a request for the device description, the Compressed XML document is decompressed on the fly as it is being transmitted to the second device. This decompression is completed by the Micro-extractor 112. Upon completion of the decompression the document will have been extracted from the stack and transmitted to the second device. The resulting UPnP XML document is functionally and data equivalent to UPNP XML document 100. UPNP devices can also act as an HTTP server for their presentation web pages. Thus, in another embodiment of the invention the document could be an HTML document, which can be decompressed and served on the fly similarly to an XML document. In yet another embodiment, the document can be any other web-based markup language that has similar qualities to XML or HTML.

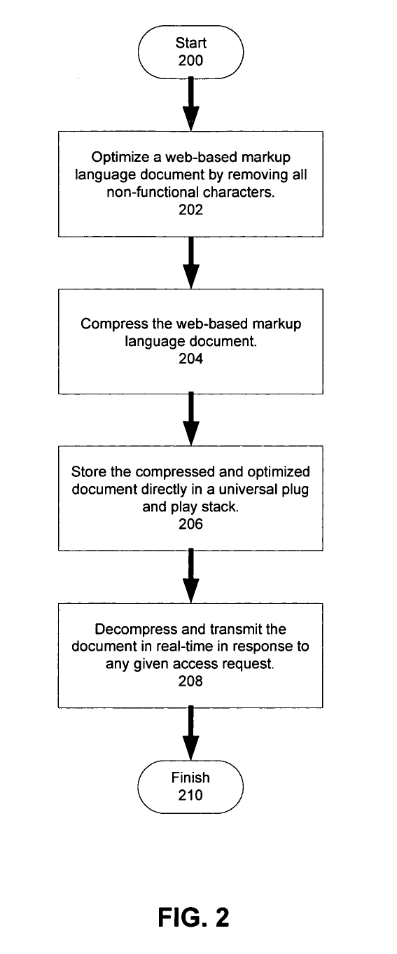

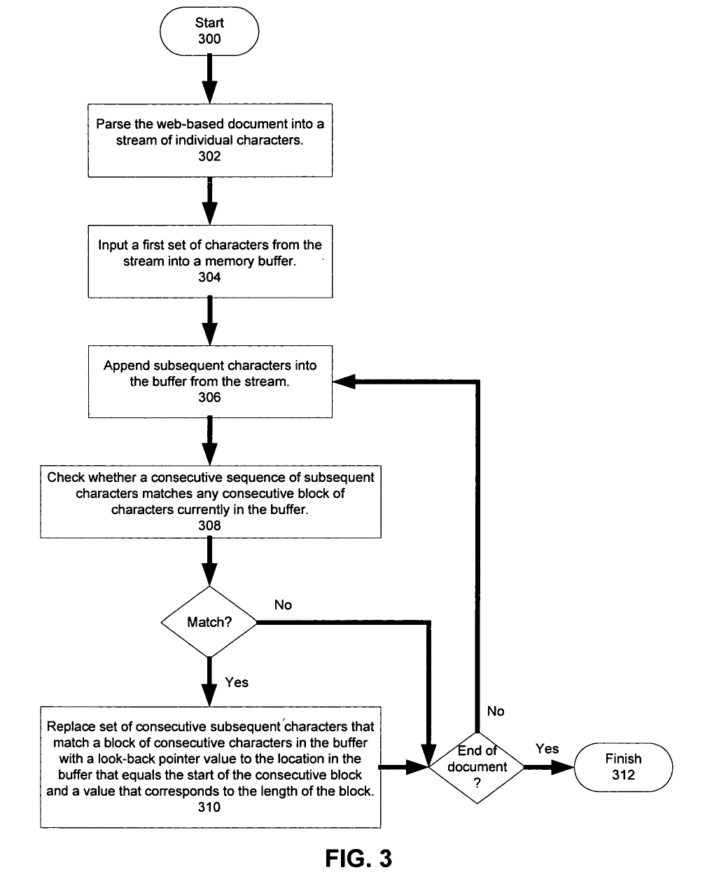

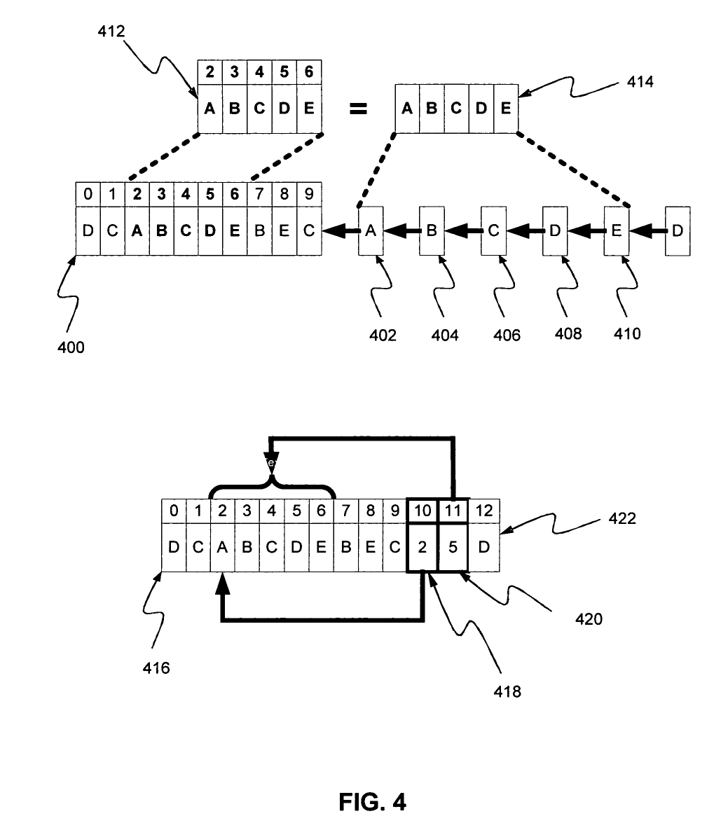

FIG. 2 illustrates a process of steps that detail one embodiment of the present invention. At the start 200 of the process a web-based markup language document is optimized by removing all non-functional characters in the document 202. Next, the web-based markup language document is compressed 204. One embodiment of the compression scheme used to compress the document is detailed in FIGS. 3 and 4. In another embodiment the compression scheme used could be any standard compression algorithm. Next, the compressed and optimized document is stored directly in a universal plug and play stack 206. Finally, the document is decompressed and transmitted in real-time in response to any given access request 208 and the process is finished 210.

FIG. 3 illustrates a process of steps that detail the compression scheme in one embodiment of the present invention. At the start 300 of the process a web-based markup language document is parsed into a stream of individual characters 302. Next, a first set of characters is input from the stream into a memory buffer 304. Then, once the buffer has been loaded with the first set of characters, subsequent characters are appended to the buffer from the stream 306. The next step is to check whether a consecutive sequence of the subsequent characters that have been added to the buffer matches any consecutive block of characters currently in the buffer 308. This check is done as each character is added to the buffer. In one embodiment, the check is done for the entire set of characters in the memory buffer. In another embodiment the check is only done within a sliding window in the buffer. The window can be of varying size and have various requirements. A standard window size is on the order of 1-Kbyte but will change depending on the document type as well as the specific type of data within the document. In one embodiment, the window will slide and remain over the most recent characters input into the buffer. If there is no match then there is another check to determine whether the document has come to and end and, thus, there are no more characters arriving from the stream. If the file has come to an end the process is finished 312, otherwise the process returns to 306 where more characters are appended to the buffer.

On the other hand, if there is a match found the set of consecutive subsequent characters that do match a block of consecutive characters in the buffer is replaced with a look-back pointer value to the location in the buffer that points to the start of the consecutive block and a value that corresponds to the length of the block 310. This allows the entire set of subsequent appended characters to be replaced by a two-byte value and the document decreases in size by the length of the block minus two bytes. Therefore, the minimum number of sequential characters that need to match in order for a decrease in size is three because otherwise there wouldn't be a size decrease. In one embodiment the minimum size required to justify a pointer/length value replacement would need to be more than three characters because of the overhead associated with the replacement. Finally, there is a check to see if the file has come to an end after the replacement. If this is the case then the process finishes 312, otherwise the process returns to 306 where more characters are appended to the buffer.

The size in bits of the pointer and length values in the two-byte replacement value can be distributed in various arrangements. Depending on the type of document, the size of the sliding window, and the speed of the device the pointer value can longer, shorter, or the same length in bits as the length value. For example, in one embodiment the pointer can be a 10-bit value (which would allow the pointer to point backwards into the buffer at up to 1-Kbyte) and the block length would therefore be a 6-bit value (which would allow matching blocks up to 64 bytes long). Alternatively, in another embodiment the pointer can be an 8-bit value (which would allow the pointer to point backwards into the buffer at up to 256 bytes) and the block length would therefore be also an 8-bit value (which would allow matching blocks up to 256 bytes long). Other differing bit length pairs of values can be used in other embodiments to utilize the compression scheme most efficiently. In another embodiment, the replacement value would not be two bytes but some other number of bits greater or less than two bytes.

FIG. 4 illustrates one example of the compression scheme working in one embodiment of the present invention. In one embodiment a first set of characters from a web-based document is input into a memory buffer 400. Additional characters from the web-based document are appended to the end of the memory buffer (402-410). A match is found between a consecutive set of characters that reside in the buffer 412 and a consecutive set of characters that have been input and appended to the end of the buffer 414. Instead of just leaving the matching set 414 appended to the end of the memory buffer 400, the matching set 414 is replaced with a pointer value 418 to the location in the memory buffer where the block begins (position 2 in the buffer) and a length value 420 to notify how many characters the block length is (length of 5). Once this replacement process is complete more characters 422 are appended to the newly modified memory buffer 416.

Upon completion of the compression algorithm a compressed web-based document such as the UPNP device description document or a UPnP service description document is stored directly in the UPnP stack on the device. This algorithm can be repeated for all compatible web-based documents that are to be stored on the UPNP stack located on the device. The document compression scheme should allow somewhere between a 6:1 to 9.5:1 compression ratio, which reduces the memory/storage space required to Depending on the amount and size of the web-based documents the entire UPnP stack footprint on the memory/storage located on the device can be reduced by 10% or greater. This is significant considering many of these devices are handheld and have limited storage capacity.

Once the device with the UPNP stack is accessed by a second device or control point on the network, the compressed documents must be decompressed by the Micro-extractor prior to being transferred to the second device. The decompression algorithm can be implemented in as small as 10 lines of code. It specifically is just a reversed process of the compression algorithm described above and in FIGS. 3 and 4. In one embodiment, the compression algorithm can be modified to only compress sequences of data over a certain size to balance the storage capabilities of the device with the processing power of the device to allow decompression in real-time as the documents are being accessed.

In another embodiment, outside the current space of UPNP, a compressed web-based document stored on a first device can be sent to a second requesting device as a compressed document and then decompressed on-the-fly on the second device. In yet another embodiment, the Micro-extractor can be embedded within the web-based document itself so the extraction capabilities are self-contained within the document such as in a Javascript routine. The document can be sent from one device to a second device compressed and the second device can use the compression algorithm embedded within the document to decompress the document. An embedded compression algorithm can be modified on a document by document basis to account for content, device speed, device storage capability, and transfer speed.

Thus, an efficient UPnP markup language document optimization and compression scheme is disclosed. These embodiments have been described with reference to specific exemplary embodiments thereof. It will, however, be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

1. A method, comprising:
optimizing a web-based markup language document by removing all non-functional characters;
compressing the document;
storing the compressed and optimized document directly in a universal plug and play stack; and
decompressing and transmitting the document in real-time in response to any given access request.

2. The method of claim 1 wherein storing the compressed and optimized document directly into a universal plug-and-play stack further comprises storing the document on a first device connected to a network.

3. The method of claim 2 wherein any given access further comprises any access by a second device connected to the network.

4. The method of claim 3, wherein decompressing the document in real-time to be available for any given access further comprises decompressing the document when the document is accessed by a device on the network.

5. The method of claim 1, wherein removing all non-functional characters further comprises eliminating any markup language comments, carriage returns, line feeds, spaces, or tab characters that are not relevant to the functionality of the data in the document.

6. The method of claim 1, wherein storing the compressed and optimized document directly into a universal plug-and-play stack further comprises replacing an un-optimized and uncompressed document with the corresponding optimized and compressed document in the same location within the stack code.

7. The method of claim 1, wherein compressing the document further comprises:
parsing the web-based document into a stream of individual characters;
inputting a first set of characters from the stream into a memory buffer;
appending subsequent characters into the buffer from the stream;
checking whether a consecutive sequence of subsequent characters matches any consecutive block of characters currently in the buffer; and
replacing any set of consecutive subsequent characters that match a block of consecutive characters in the buffer with a look-back pointer value to the location in the buffer that equals the start of the consecutive block and a value that corresponds to the length of the block.

8. The method of claim 7, wherein the look-back pointer and length values further comprise a combined byte-length value of one or more bytes, the pointer and length values each having assigned a specific number of bits of the byte-length value weighted according to the best possible compression of a given document.

9. The method of claim 8, wherein the distribution of bits between the pointer and length values is partially based on the speed required for decompression.

10. The method of claim 7 further comprising limiting the compression scheme to only compress sequences of characters longer than a certain length.

11. A method, comprising:
optimizing a web-based markup language document by removing all non-functional characters;
compressing the document;
storing the compressed and optimized document;
transmitting the document in response to any given access request; and
decompressing the document upon arrival at the access request location.

12. The method of claim 11 wherein storing the compressed and optimized document further comprises storing the document on a first device connected to a network.

13. The method of claim 12 wherein any given access further comprises any access by a second device connected to the network.

14. The method of claim 13, wherein decompressing the document upon arrival at the access request location further comprises decompressing the document when the document arrives at the second device on the network after transmittal from the first device on the network.

15. The method of claim 14, wherein decompressing the document when the document arrives at the second device further comprises, utilizing a micro-extraction algorithm embedded within the transmitted document itself to decompress the document.

16. A machine readable medium having embodied thereon instructions, which when executed by a machine, comprises:
optimizing a web-based markup language document by removing all non-functional characters;
compressing the document;
storing the compressed and optimized document directly in a universal plug and play stack; and
decompressing and transmitting the document in real-time in response to any given access request.

17. The machine readable medium of claim 16 wherein storing the compressed and optimized document directly into a universal plug-and-play stack further comprises storing the document on a first device connected to a network.

18. The machine readable medium of claim 17 wherein any given access further comprises any access by a second device connected to the network.

19. The machine readable medium of claim 18, wherein decompressing the document in real-time to be available for any given access further comprises decompressing the document when the document is accessed by a device on the network.

20. The machine readable medium of claim 19 further comprising decompressing the document

21. The machine readable medium of claim 16, wherein removing all non-functional characters further comprises eliminating any markup language comments, carriage returns, line feeds, spaces, or tab characters that are not relevant to the functionality of the data in the document.

22. The machine readable medium of claim 16, wherein storing the compressed and optimized document directly into a universal plug-and-play stack further comprises replacing an un-optimized and uncompressed document with the corresponding optimized and compressed document in the same location within the stack code.

23. The machine readable medium of claim 16, wherein compressing the document further comprises:
parsing the web-based document into a stream of individual characters;
inputting a first set of characters from the stream into a memory buffer;
appending subsequent characters into the buffer from the stream;
checking whether a consecutive sequence of subsequent characters matches any consecutive block of characters currently in the buffer; and
replacing any set of consecutive subsequent characters that match a block of consecutive characters in the buffer with a look-back pointer value to the location in the buffer that equals the start of the consecutive block and a value that corresponds to the length of the block.

24. A system, comprising:
a bus;
a processor coupled to the bus;
a network interface card coupled to the bus; and
memory coupled to the processor, the memory adapted for storing instructions, which upon execution by the processor optimize a web-based markup language document by removing all non-functional characters, compress the document, store the compressed and optimized document directly in a universal plug and play stack, and decompress and transmit the document in real-time in response to any given access request.

25. The system of claim 24 wherein storing the compressed and optimized document directly into a universal plug-and-play stack further comprises storing the document on a first device connected to a network.

26. The system of claim 25 wherein any given access further comprises any access by a second device connected to the network.

27. The system of claim 26, wherein decompressing the document in real-time to be available for any given access further comprises decompressing the document when the document is accessed by a device on the network.

28. The system of claim 27 further comprising decompressing the document

29. The system of claim 28, wherein removing all non-functional characters further comprises eliminating any markup language comments, carriage returns, line feeds, spaces, or tab characters that are not relevant to the functionality of the data in the document.

30. The system of claim 24, wherein storing the compressed and optimized document directly into a universal plug-and-play stack further comprises replacing an un-optimized and uncompressed document with the corresponding optimized and compressed document in the same location within the stack code.

31. The system of claim 24, wherein compressing the document further comprises:
parsing the web-based document into a stream of individual characters;
inputting a first set of characters from the stream into a memory buffer;
appending subsequent characters into the buffer from the stream;
checking whether a consecutive sequence of subsequent characters matches any consecutive block of characters currently in the buffer; and
replacing any set of consecutive subsequent characters that match a block of consecutive characters in the buffer with a look-back pointer value to the location in the buffer that equals the start of the consecutive block and a value that corresponds to the length of the block.

32. The system of claim 31, wherein the look-back pointer and length values further comprise a combined byte-length value of one or more bytes, the pointer and length values each having assigned a specific number of bits of the byte-length value weighted according to the best possible compression of a given document.

33. The system of claim 32, wherein the distribution of bits between the pointer and length values is partially based on the speed required for decompression.

34. The system of claim 33 further comprising limiting the compression scheme to only compress sequences of characters longer than a certain length.
